(19) United States
(12) Patent Application Publication
(10) Pub. No.: US 2022/0109329 A1
(43) Pub. Date: Apr. 7, 2022

(54) BATTERY PACK, NON-CONTACT CHARGING SYSTEM, AND POWER TOOL

(71) Applicant: Mitsubishi Electric Engineering Company, Limited, Tokyo (JP)

(72) Inventor: Kiyohide SAKAI, Tokyo (JP)

(73) Assignee: Mitsubishi Electric Engineering Company, Limited, Tokyo (JP)

(21) Appl. No.: 17/426,659

(22) PCT Filed: Aug. 25, 2020
(86) PCT No.: PCT/JP2020/031925

§ 371 Date: Jul. 29, 2021

(51) Int. Cl. H02J 50/12; H02J 50/00; H01M 10/44

(52) U.S. Cl. CPC H02J 50/12; H01M 2220/30; H01M 10/44; H02J 50/005

(57) ABSTRACT

The battery pack includes a housing for storing a battery cell, a power receiving coil that is provided to extend on a plurality of inner faces of the housing, and receives power from the power feeding coil of a power supply device in a non-contact manner by magnetically resonating with a power feeding coil, and a charging circuit stored in the housing and supplying the power received by the power receiving coil to the battery cell.

### TECHNICAL FIELD

The present disclosure relates to battery packs, non-contact charging systems, and power tools.

### BACKGROUND ART

Some power tools are equipped with a battery pack. The battery pack is charged, for example, using a charging system.

Some charging systems charge the battery pack by transmitting power from a power supply device to the battery pack in a non-contact manner. Such a battery pack capable of non-contact charging is disclosed in, for example, Patent Literature 1.

### CITATION LIST

### Patent Literature

Patent Literature 1: Japanese Patent No. 5569717

### SUMMARY OF INVENTION

### Technical Problem

The battery pack disclosed in Patent Literature 1 has a power receiving coil. On the other hand, the power supply device has a power feeding coil. The power feeding coil and the power receiving coil have similar figures. When the power feeding coil and the power receiving coil face each other within a predetermined distance, most of the magnetic flux generated by the power feeding coil penetrates the power receiving coil. The battery pack disclosed in Patent Literature 1 is charged by being placed on the power supply device so that the power feeding coil and the power receiving coil face each other.

Therefore, when the battery pack disclosed in Patent Literature 1 is being charged, if the battery pack is laterally displaced or lifted with respect to the power supply device, the power feeding coil and the power receiving coil do not face each other. As a result, the battery pack may not be properly charged.

The present disclosure has been made to solve the above-described problem, and has an object to provide a battery pack capable of non-contact charging even if lateral displacement or lifting thereof occurs with respect to the power supply device.

### Solution to Problem

The battery pack according to the present disclosure includes a housing for storing a battery cell; a power receiving coil that is provided to extend on a plurality of inner faces of the housing, and receives power from a power feeding coil of a power supply device in a non-contact manner by magnetically resonating with the power feeding coil; and a charging circuit stored in the housing and supplying the power received by the power receiving coil to the battery cell.

### Advantageous Effects of Invention

According to the present disclosure, non-contact charging can be performed even if lateral displacement or lifting occurs with respect to the power supply device.

### BRIEF DESCRIPTION OF DRAWINGS

FIG. 1 is a schematic view showing a configuration of a non-contact charging system and a power tool to which a battery pack according to a first embodiment is each applied.

FIG. 2 is a perspective view showing a configuration of the non-contact charging system to which the battery pack according to the first embodiment is applied.

FIG. 3 is a cross-sectional view taken along the line in FIG. 2.

FIG. 4 is a diagram showing the relationship between a distance between coils and a coupling efficiency between coils.

FIG. 5 is a cross-sectional view showing a configuration of a non-contact charging system to which a battery pack according to a second embodiment is applied.

FIG. 6 is a schematic diagram showing a configuration of a non-contact charging system to which a battery pack according to a third embodiment is applied.

### DESCRIPTION OF EMBODIMENTS

In order to explain the present disclosure in more detail, some modes for carrying out the present disclosure will be described below with reference to the accompanying drawings.

### First Embodiment

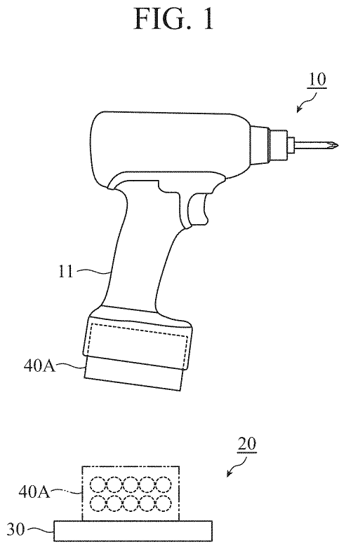

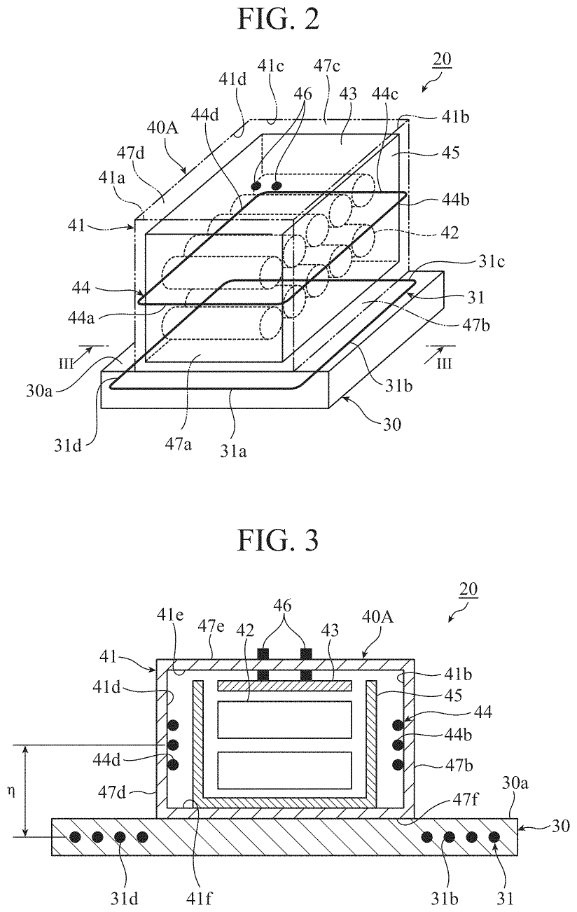

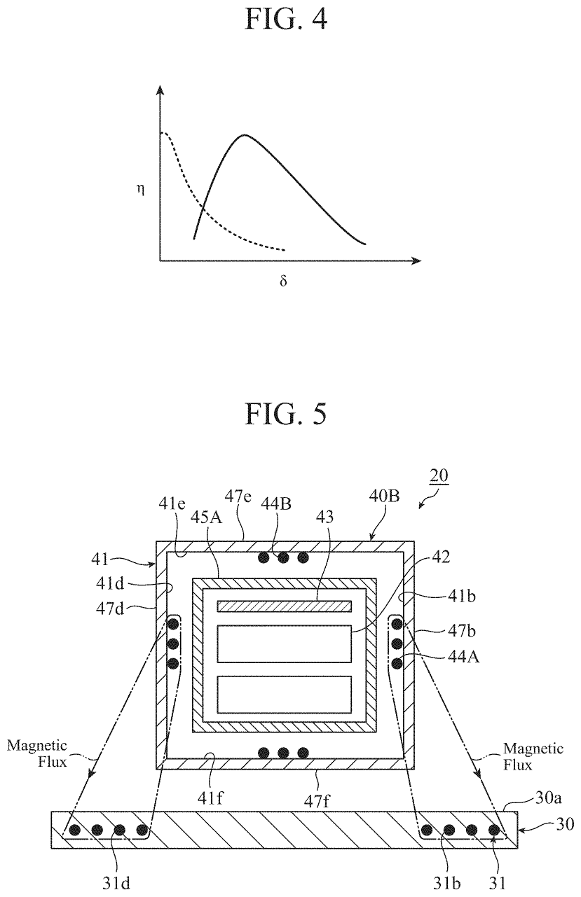

A battery pack 40A according to the first embodiment will be described with reference to FIGS. 1 to 4. FIG. 1 is a schematic view showing a configuration of a non-contact charging system 20 and a power tool 10 to which the battery pack 40A according to the first embodiment is each applied. FIG. 2 is a perspective view showing a configuration of the non-contact charging system 20 to which the battery pack 40A according to the first embodiment is applied. FIG. 3 is a cross-sectional view taken along the line of FIG. 2. FIG. 4 is a diagram showing the relationship between a distance between coils and a coupling efficiency between coils.

As shown in FIG. 1, the power tool 10 includes a tool body 11 and the battery pack 40A. The power tool 10 is, for example, an electric drill or the like. Further, the non-contact charging system 20 includes a power supply device 30 and the battery pack 40A.

The battery pack 40A supplies power to the tool body 11 by electrically connecting to the tool body 11. The tool body 11 is driven by using the power supplied from the battery pack 40A. Further, the battery pack 40A can be charged in a non-contact manner by using the power supply device 30.

The non-contact charging system 20 shown in FIGS. 2 and 3 is a system that performs non-contact charging using, for example, a magnetic field resonance method. The non-contact charging system 20 transmits power from the power supply device 30 to the battery pack 40A in a non-contact manner to charge the battery pack 40A.

The battery pack 40A has a housing 41, a battery cell 42, a charging circuit 43, a power receiving coil 44, a magnetic sheet 45, and an electrode 46.

The housing 41 forms the outer shell of the battery pack 40A. The housing 41 has a hollow structure, and stores the battery cell 42, the charging circuit 43, the power receiving coil 44, and the magnetic sheet 45 therein. The housing 41 is made of, for example, resin material.

Further, the housing 41 has inner faces 41a, 41b, 41c, 41d, a ceiling face 41e, and a bottom face 41f. The inner faces 41a, 41b, 41c, 41d, the ceiling face 41e, and the bottom face 41f constitute the inner faces of the housing 41.

At least one battery cell 42 is stored in the housing 41. The battery cell 42 is attached to the bottom face 41f of the housing 41 via the magnetic sheet 45 described later. Note that FIGS. 2 and 3 show an example in which a plurality of (10) battery cells 42 are stored in the housing 41. The battery cell 42 stores power for driving the power tool 10. Further, the battery cell 42 supplies the stored power to the tool body 11 via the electrode 46 described later.

The charging circuit 43 is disposed above the battery cells 42. The charging circuit 43 rectifies the power generated by the power receiving coil 44, which will be described later, and supplies it to the battery cells 42.

The power receiving coil 44 is provided to extend on the inner faces 41a to 41d of the housing 41 so as to form a loop. The power receiving coil 44 forms a loop so as to surround the battery cells 42. Such a power receiving coil 44 receives power from the power feeding coil 31 by magnetically resonating with a power feeding coil 31 of a power supply device 30 described later.

Further, the power receiving coil 44 has a rectangular shape because it is provided to extend on the inner faces 41a to 41d of the housing 41. Therefore, the power receiving coil 44 is divided into straight portions 44a, 44b, 44c, 44d. The straight portion 44a faces the inner face 41a. The straight portion 44b faces the inner face 41b. The straight portion 44c faces the inner face 41c. The straight portion 44d faces the inner face 41d.

The magnetic sheet 45 is provided so as to cover the battery cells 42 and the charging circuit 43 from below them. Further, the magnetic sheet 45 is attached to the bottom face 41f of the housing 41. The magnetic sheet 45 is made of, for example, soft magnetic material and blocks magnetic flux.

Here, the battery cell 42 and the charging circuit 43 are mainly made of metal material. When the battery cell 42 and the charging circuit 43, which are metal members, are present in the vicinity of the power receiving coil 44, an eddy current is generated in the battery cell 42 and the charging circuit 43 due to the magnetic flux generated around the power feeding coil 31 described later. This eddy current may heat or thermally deteriorate the battery cell 42 and the charging circuit 43.

Thus, in the battery pack 40A, by covering the space around the battery cells 42 and the charging circuit 43 with the magnetic sheet 45, the magnetic flux generated by the power feeding coil 31 passes through the external space of the magnetic sheet 45 and the inside of the magnetic sheet 45 itself, and the magnetic flux is prevented from entering the battery cells 42 and the charging circuit 43. Therefore, in the battery pack 40A, heating or thermal deterioration of the battery cells 42 and the charging circuit 43 due to the eddy current can be suppressed.

The electrode 46 is provided on the upper face of the housing 41 and is electrically connected to the charging circuit 43. The upper face of the housing 41 is an opposite face of the ceiling face 41e and is the upper face 47e of the battery pack 40A. When the battery pack 40A is attached to the tool body 11, the electrode 46 is electrically connected to the electrode (not shown) of the tool body 11. Thus, the charging circuit 43 supplies the power stored in the battery cell 42 to the tool body 11 via the electrode 46.

On the other hand, the power supply device 30 has a power feeding coil 31. As described above, the power feeding coil 31 supplies power to the power receiving coil 44 in a non-contact manner by magnetically resonating with the power receiving coil 44.

The power feeding coil 31 is built in the power supply device 30, and is widely disposed below the upper face 30a of the power supply device 30. The upper face 30a of the power supply device 30 is a face on which the lower face 47f of the battery pack 40A is placed when the battery pack 40A is charged. The lower face 47f of the battery pack 40A is a lower face of the housing 41 and is an opposite face of the bottom face 41f.

Further, the power feeding coil 31 has a rectangular shape when viewed from above. Thus, the power feeding coil 31 has straight portions 31a, 31b, 31c, 31d. The straight portion 31a corresponds to the straight portion 44a of the power receiving coil 44. The straight portion 31b corresponds to the straight portion 44b of the power receiving coil 44. The straight portion 31c corresponds to the straight portion 44c of the power receiving coil 44. The straight portion 31d corresponds to the straight portion 44d of the power receiving coil 44.

Therefore, in the non-contact charging system 20, when power is supplied to the power feeding coil 31 of the power supply device 30, a strong magnetic field is generated around the power feeding coil 31. At this time, when the battery pack 40A approaches the upper face 30a of the power supply device 30, the power receiving coil 44 is exposed to the magnetic field generated around the power feeding coil 31, and the power feeding coil 31 and the power receiving coil 44 magnetically resonate with each other. Consequently, the power supplied to the power feeding coil 31 of the power supply device 30 is sent in a non-contact manner toward the power receiving coil 44 by the magnetic field resonance. Then, when power is supplied to the power receiving coil 44, the power is sent to the battery cells 42 via the charging circuit 43 to charge the battery cells 42.

Further, since the non-contact charging system 20 adopts a magnetic field resonance method for the coupling between the power feeding coil 31 and the power receiving coil 44, compared with the case where the electromagnetic induction method is adopted for the coupling between them, it is possible to improve the coupling efficiency between them, even if the distance between the power feeding coil 31 and the power receiving coil 44 is relatively long. Therefore, even if the lower face 47f of the battery pack 40A is placed to be laterally displaced in a horizontal direction with respect to the upper face 30a of the power supply device 30, at least one set among a set of straight portions 31a, 44a, a set of straight portions 31b, 44b, a set of straight portions 31c, 44c, and a set of straight portions 31d, 44d magnetically resonates with each other.

This point will be described with reference to FIG. 4. The solid line shown in FIG. 4 shows the relationship between a distance δ (see FIG. 3) between the power feeding coil 31 and the power receiving coil 44 and a coupling efficiency η between them in the non-contact charging system 20 using the magnetic field resonance method. The broken line shown in FIG. 4 shows the relationship between a distance δ between the power feeding coil and the power receiving coil and a coupling efficiency η between them in a non-contact charging system using the electromagnetic induction method. The non-contact charging system using the electromagnetic induction method is, for example, the non-contact charging system disclosed in Patent Literature 1.

As shown in FIG. 4, in the non-contact charging system using the electromagnetic induction method, the shorter the distance δ is, the larger the coupling efficiency η is. Further, as the distance δ becomes longer, the coupling efficiency η sharply decreases. Therefore, in a non-contact charging system using an electromagnetic induction method, when the lower face of the battery pack is placed on the upper face of the power supply device, if the power feeding coil and the power receiving coil face each other correctly in the vertical direction, the battery pack is properly charged.

However, in the non-contact charging system using the electromagnetic induction method, for example, when the lower face of the battery pack is placed to be laterally displaced with respect to the upper face of the power supply device, or when some object lies between the lower face of the battery pack and the upper face of the power supply device so that the battery pack is lifted, the power feeding coil and the power receiving coil do not face each other correctly in the vertical direction, so that the battery pack is not charged. Such an object is, for example, rainwater, soil, grit, dust, or the like.

On the other hand, in the non-contact charging system 20 using the magnetic field resonance method, the output impedance of the power supply device 30 and the input impedance of the battery pack 40 match at a predetermined distance δ (δ>0), and therefore, the value of the coupling efficiency η becomes the maximum. Further, before and after the maximum value of the coupling efficiency the coupling efficiency η gradually decreases.

Namely, in the non-contact charging system 20 using the magnetic field resonance method, in the effective range of the distance δ, the coupling efficiency η does not drop sharply. Thus, when the lower face 47f of the battery pack 40A is placed to be laterally displaced with respect to the upper face 30a of the power supply device 30, and also when the lower face 47f of the battery pack 40A is lifted with respect to the upper face 30a of the power supply device 30, the battery pack 40A is properly charged. That is, in the non-contact charging system 20, even when the mutual inductance between the power feeding coil 31 and the power receiving coil 44 is relatively small, it is possible to appropriately match the impedance between the power feeding coil 31 and the power receiving coil 44 and increase the coupling efficiency η.

As described above, the battery pack 40A according to the first embodiment includes the housing 41 for storing battery cells 42, the power receiving coil 44 that is provided to extend on a plurality of inner faces of the housing 41 and receives power from the power feeding coil 31 of the power supply device 30 in a non-contact manner by magnetically resonating with the power feeding coil 31, and the charging circuit 43 that is stored in the housing 41 and supplying the power received by the power receiving coil 44 to the battery cells 42. As a result, the battery pack 40A can perform non-contact charging even if lateral displacement or lifting occurs with respect to the power supply device 30.

Further, the power receiving coil 44 is provided to extend on a plurality of inner faces 41a to 41d of the housing 41 that does not face the upper face 30a of the power supply device 30. Therefore, for the battery pack 40A, the distance between the power feeding coil 31 and the power receiving coil 44 can be appropriately set, and the magnetic field resonance method can be easily adopted for the coupling between them.

The non-contact charging system 20 according to the first embodiment includes the battery pack 40A and the power supply device 30 having the power feeding coil 31, so that the battery pack 40A can be charged in a non-contact manner, even if lateral displacement or lifting of the battery pack 40A occurs with respect to the power supply device 30.

The power tool 10 according to the first embodiment includes a battery pack 40A and a tool body 11 to which the battery pack 40A is electrically attached. Therefore, the battery pack 40A of the power tool 10 can perform non-contact charging even if lateral displacement or lifting occurs with respect to the power supply device 30.

### Second Embodiment

A battery pack 40B according to a second embodiment will be described with reference to FIG. 5. FIG. 5 is a cross-sectional view showing the configuration of the non-contact charging system 20 to which the battery pack 40B according to the second embodiment is applied.

The battery pack 40B according to the second embodiment has power receiving coils 44A, 44B and a magnetic sheet 45A in place of the power receiving coil 44 and the magnetic sheet 45 of the battery pack 40A according to the first embodiment.

The magnetic sheet 45A is provided so as to cover the battery cells 42 and the charging circuit 43 from the outside thereof.

The power receiving coil 44A is provided to extend on the inner faces 41a to 41d (see FIG. 2) of the housing 41 so that it forms a rectangular shape. Therefore, the power receiving coil 44A is divided into straight portions respectively facing inner faces 41a to 41d.

The power receiving coil 44B is provided to extend on the inner face 41a, the bottom face 41f, the inner face 41c, and the ceiling face 41e (see FIGS. 2 and 3) of the housing 41. Therefore, the power receiving coil 44B is divided into straight portions facing the inner face 41a, the bottom face 41f, the inner face 41c, and the ceiling face 41e.

That is, the power receiving coils 44A, 44B each form a loop and orthogonally cross each other.

The straight portion 31a (see FIG. 2) of the power feeding coil 31 corresponds to a straight portion facing the inner face 41a of the power receiving coil 44A and a straight portion facing the inner face 41a of the power receiving coil 44B.

The straight portion 31c (see FIG. 2) of the power feeding coil 31 corresponds to a straight portion of the power receiving coil 44A facing the inner face 41c and a straight portion of the power receiving coil 44B facing the inner face 41c.

The straight portions 31b, 31d of the power feeding coil 31 correspond to the straight portions of the power receiving coil 44A facing the inner faces 41b, 41d. Further, the straight portions 31b, 31d of the power feeding coil 31 correspond to the straight portions of the power receiving coil 44B facing the ceiling face 41e and the bottom face 41f.

Here, as shown in FIGS. 2 and 5, the battery pack 40B has side faces 47a to 47d, an upper face 47e, and a lower face 47f which are opposite sides of the inner faces 41a to 41d, the ceiling face 41e, and the bottom face 41f of the housing 41, respectively.

Therefore, since the battery pack 40B has the power receiving coils 44A, 44B, when one of the side faces 47b, 47d, the upper face 47e, and the lower face 47f (see FIG. 3) is placed on the upper face 30a of the power supply device 30, the battery pack 40B is properly charged. In other words, the battery pack 40B is properly charged in any of vertical, upside down, and horizontal placement. That is, the battery pack 40B can increase the degree of freedom of placement during non-contact charging.

Note that, the vertical placement of the battery pack 40B means disposition in which the lower face 47f thereof is placed on the upper face 30a of the power supply device 30. The upside-down placement of the battery pack 40B means disposition in which the upper face 47e thereof is placed on the upper face 30a of the power supply device 30. The horizontal placement of the battery pack 40B means disposition in which the side faces 47b, 47d thereof are placed on the upper face 30a of the power supply device 30.

At this time, in the non-contact charging system 20 using the magnetic field resonance method, when the side faces 47b, 47d, the upper face 47e, and the lower face 47f of the battery pack 40B are placed being laterally displaced with respect to the upper face 30a of the power supply device 30, or even when the side faces 47b, 47d, the upper face 47e, and the lower face 47f of the battery pack 40B are lifted with respect to the upper face 30a of the power supply device 30, the battery pack 40B is properly charged.

As described above, the battery pack 40B according to the second embodiment has two power receiving coils 44A, 44B that each form a loop and orthogonally cross each other. Therefore, the battery pack 40B can be properly charged not only in vertical placement, but also in upside down and horizontal placement.

### Third Embodiment

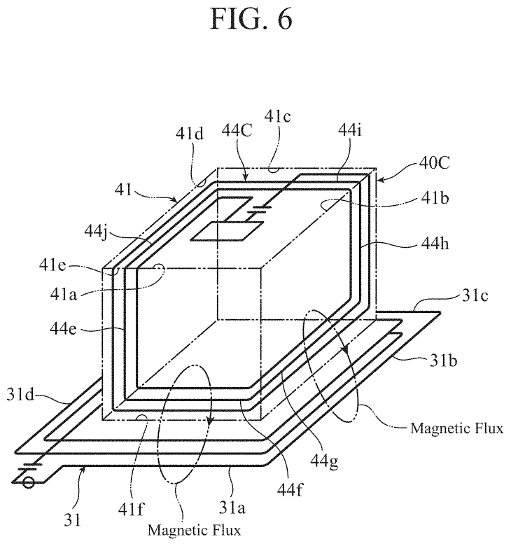

A battery pack 40C according to the third embodiment will be described with reference to FIG. 6. FIG. 6 is a schematic view showing the configuration of the non-contact charging system 20 to which the battery pack 40C according to the third embodiment is applied.

The battery pack 40C according to the third embodiment has a power receiving coil 44C in place of the power receiving coil 44 of the battery pack 40A according to the first embodiment. The power receiving coil 44C is provided to extend on three adjacent inner faces of the housing 41. Note that, FIG. 6 shows an example in which the power receiving coil 44C is provided to extend on the adjacent inner faces 41a, 41b and the ceiling face 41e of the housing 41. Therefore, the power receiving coil 44C is divided into straight portions 44e, 44f, 44g, 44h, 44i, 44j.

The straight portions 44e, 44f face the inner face 41a. The straight portions 44e, 44f are orthogonal to each other. Further, the straight portions 44e, 44f correspond to the straight portions 31a, 31c of the power feeding coil 31.

The straight portions 44g, 44h face the inner face 41b. The straight portions 44g, 44h are orthogonal to each other. Further, the straight portion 44g corresponds to the straight portions 31b, 31d of the power feeding coil 31. The straight portion 44h corresponds to the straight portions 31a, 31c of the power feeding coil 31.

The straight portions 44i, 44j face the ceiling face 41e. The straight portions 44i, 44j face each other. Further, the straight portion 44i corresponds to the straight portions 31a, 31c of the power feeding coil 31. The straight portion 44j faces the straight portions 31b, 31d of the power feeding coil 31.

Therefore, since the battery pack 40C has the power receiving coil 44C, when any one of the side faces 47b, 47d, the upper face 47e, and the lower face 47f (see FIG. 3) is placed on the upper face 30a of the power supply device 30, the battery pack 40C is properly charged. In other words, the battery pack 40C is properly charged in any of the vertical, upside-down, and horizontal placement. That is, the battery pack 40B can increase the degree of freedom of placement during non-contact charging.

Specifically, when the side face 47b is placed on the upper face 30a, the straight portion 44g magnetically resonates with the straight portion 31b, and the straight portion 44h magnetically resonates with the straight portion 31a. Alternatively, the straight portion 44g magnetically resonates with the straight portion 31d, and the straight portion 44h magnetically resonates with the straight portion 31c.

When the side face 47d is placed on the upper face 30a, the straight portion 44e magnetically resonates with the straight portion 31a, and the straight portion 44j magnetically resonates with the straight portion 31d. Alternatively, the straight portion 44e magnetically resonates with the straight portion 31c, and the straight portion 44j magnetically resonates with the straight portion 31b.

When the upper face 47e is placed on the upper face 30a, the straight portion 44i magnetically resonates with the straight portion 31a, and the straight portion 44j magnetically resonates with the straight portion 31d. Alternatively, the straight portion 44i magnetically resonates with the straight portion 31c, and the straight portion 44j magnetically resonates with the straight portion 31b.

When the lower face 47f is placed on the upper face 30a, the straight portion 44f magnetically resonates with the straight portion 31a, and the straight portion 44g magnetically resonates with the straight portion 31b (see FIG. 6). Alternatively, the straight portion 44f magnetically resonates with the straight portion 31c, and the straight portion 44g magnetically resonates with the straight portion 31d.

At this time, when the side faces 47b, 47d, upper face 47e, and lower face 47f of the battery pack 40C are placed being laterally displaced with respect to the upper face 30a of the power supply device 30, or when the side faces 47b, 47d, upper face 47e and lower face 47f of the battery pack 40B are lifted with respect to the upper face 30a of the power supply device 30, at least one of the two magnetic field resonances described above occurs on each of the faces, so the battery pack 40C is properly charged.

As described above, the power receiving coil 44C in the battery pack 40C according to the third embodiment is provided to extend on the adjacent inner faces 41a, 41b and the ceiling face 41e of the housing 41. Therefore, the battery pack 40C can be properly charged not only in vertical placement but also in upside down and horizontal placement.

Note that, in the present disclosure, within the scope of the disclosure, any combination of the embodiments, modification of any component in each embodiment, or omission of any component in each embodiment is possible.

### INDUSTRIAL APPLICABILITY

The battery pack according to the present disclosure includes a power receiving coil that is provided to extend on a plurality of inner faces of the housing and magnetically resonates with a power feeding coil of the power supply device, and can be charged in a non-contact manner even if lateral displacement or lifting occurs with respect to the power supply device, and it is suitable for use in a battery pack or the like.

### REFERENCE SIGNS LIST

10: power tool, 11: tool body, 20: non-contact charging system, 30: power supply device, 30a: upper face, 31: power feeding coil, 31a to 31d: straight portion, 40A, 40B, 40C: battery pack, 41: housing, 41a to 41d: inner face, 41e: ceiling face, 41f: bottom face, 42: battery cell, 43: charging circuit, 44, 44A, 44B, 44C: power receiving coil, 44a to 44d, 44e to 44j: straight portion, 45, 45A: magnetic sheet, 46: electrode, 47a to 47d: side face, 47e: upper face, 47f: lower face

1. A battery pack comprising:
a housing for storing a battery cell;
a power receiving coil that is provided to extend on a plurality of inner faces of the housing, and receives power from a power feeding coil of a power supply device in a non-contact manner by magnetically resonating with the power feeding coil; and
a charging circuit stored in the housing and supplying the power received by the power receiving coil to the battery cell.

2. The battery pack according to claim 1, wherein the power receiving coil is provided to extend on the plurality of inner faces of the housing that does not face an upper face of the power supply device.

3. The battery pack according to claim 1, wherein the power receiving coil is configured to form a loop, and the battery pack further comprises another power receiving coil being configured to form another loop and orthogonally crossing the power receiving coil.

4. The battery pack according to claim 1, wherein the power receiving coil is provided to extend on three adjacent inner faces of the housing.

5. A non-contact charging system, comprising:
the battery pack according to claim 1; and
the power supply device having the power feeding coil.

6. A power tool comprising:
the battery pack according to claim 1; and
a tool body to which the battery pack is electrically attached.
